(19) United States
(12) Patent Application Publication
(10) Pub. No.: US 2026/0303893 A1
(43) Pub. Date: Oct. 1, 2026

(54) STREAMING SYSTEM, STREAMING METHOD, STORAGE MEDIUM, AND IN-VEHICLE APPARATUS

(71) Applicant: HONDA MOTOR CO., LTD., Tokyo (JP)

(72) Inventor: Junichiro Onaka, Tokyo (JP)

(21) Appl. No.: 19/533,557

(22) Filed: Feb. 9, 2026

(30) Foreign Application Priority Data
Mar. 28, 2025 (JP) 2025-056401

(51) Int. Cl. H04N 21/414; H04N 21/431; H04N 21/438

(52) U.S. Cl. CPC H04N 21/41407; H04N 21/41422; H04N 21/4318; H04N 21/438

(57) ABSTRACT

A streaming system includes: a streaming unit that streams an image obtained through capturing by a capturing apparatus provided in a vehicle; a display apparatus that displays the image streamed by the streaming unit and is provided outside of the vehicle; and an output unit that outputs, from a speaker provided in the vehicle, a notification sound indicating that the display apparatus has started viewing the image, wherein the notification sound corresponding to a specific display apparatus differs from the notification sound corresponding to a display apparatus other than the specific display apparatus.

### INCORPORATION BY REFERENCE

The present application claims priority under 35 U.S.C. § 119 to Japanese Patent Application No. 2025-056401 filed on Mar. 28, 2025. The content of the application is incorporated herein by reference in its entirety.

### BACKGROUND OF THE INVENTION

### Field of the Invention

The present invention relates to a streaming system, a streaming method, a storage medium, and an in-vehicle apparatus.

### Description of the Related Art

In recent years, efforts have been accelerating to provide access to sustainable transportation systems that take into account vulnerable traffic participants such as the elderly, people with disabilities, and children. To this end, efforts are focused on research and development for further improving the safety and convenience of traffic through the development of means of transportation for vulnerable road users.

For example, a method is conceivable of viewing a moving image streamed by a streamer of an image, without a person in a vulnerable position personally having to enter a mobile body to access a transportation system. By viewing the moving image streamed by the streamer, it is possible to experience the feeling of going out or traveling.

Japanese Patent Laid-Open No. 2016-145864 discloses a vehicle display apparatus including a display part that displays vehicle information to a vehicle occupant, a connection unit that is communicably connected to a portable terminal including a portable display part, and a control unit that performs display control of the display part.

Behavior of the occupant of the vehicle may change in response to a viewer having started viewing the streamed image. However, conventional technologies have a problem in that the occupant of the vehicle is not capable of knowing that viewing of the streamed image has started on specific display apparatuses. The manner in which the occupant is notified may interfere with the occupant's concentration on driving. Furthermore, when notifying that the viewing of the streamed image on a specific display apparatus has started, there is a problem in needing to reduce a cognitive load related to the notification so that the occupant of the vehicle can concentrate on driving.

In order to solve the above problem, the present application has an object to provide a streaming system, a streaming method, a storage medium, and an in-vehicle apparatus that make it possible for an occupant to know when viewing of a streamed image on a specific display apparatus has started and to reduce a load related to the occupant recognizing a notification indicating that viewing of the streamed image on the specific display apparatus has started.

Therefore, through a service for connecting remote locations and vehicles, the present invention contributes to supporting good connection between urban areas and regional areas such as those surrounding urban areas, and to the development of sustainable transportation systems.

### SUMMARY OF THE INVENTION

An aspect of the present invention is a streaming system including: a streaming unit configured to stream an image obtained through capturing by a capturing apparatus provided in a vehicle; a display apparatus configured to display the image streamed by the streaming unit and provided outside of the vehicle; and an output unit configured to output, from a speaker provided in the vehicle, a notification sound indicating that the display apparatus has started viewing the image, wherein the notification sound corresponding to a specific display apparatus differs from the notification sound corresponding to a display apparatus other than the specific display apparatus.

According to the present invention, it is possible for an occupant to know when viewing of the streamed image on the specific display apparatus has started and to reduce a load related to the occupant recognizing a notification indicating that viewing of the streamed image on the specific display apparatus has started.

### BRIEF DESCRIPTION OF THE DRAWINGS

FIG. 1 is a diagram showing a system configuration of a streaming system;

FIG. 2 is a block diagram showing a configuration of an in-vehicle apparatus and a streaming server;

FIG. 3 is a diagram showing a detailed configuration of a first control section of the in-vehicle apparatus;

FIG. 4 is a diagram showing a configuration of a management DB;

FIG. 5 is a diagram showing a configuration of a user information DB;

FIG. 6 is a diagram showing a configuration of a stream management DB;

FIG. 7 is a block diagram showing a configuration of a terminal apparatus;

FIG. 8 shows flowcharts showing an operation of the in-vehicle apparatus and a viewer terminal; and

FIG. 9 is a diagram showing an example of a presentation screen.

### DETAILED DESCRIPTION OF THE INVENTION

Hereinafter, an embodiment of the present invention will be described with reference to the drawings.

### 1. Configuration of Streaming System

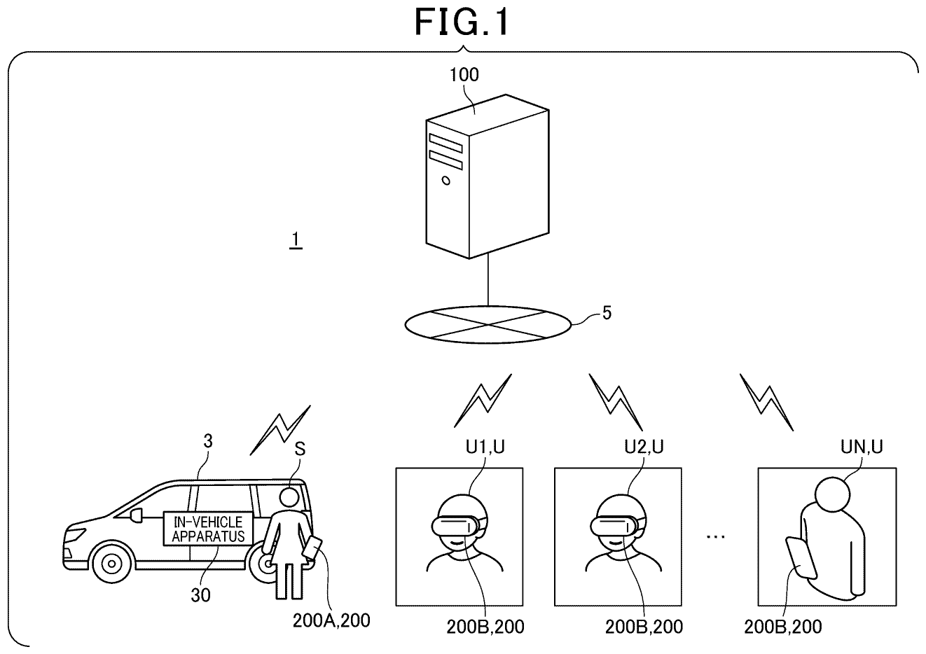

FIG. 1 is a diagram showing a system configuration of a streaming system 1.

The streaming system 1 includes a vehicle 3, an in-vehicle apparatus 30 included in the vehicle 3, a streamer terminal 200A provided in the vehicle 3, a streaming server 100, and a viewer terminal 200B provided outside of the vehicle 3. The streaming system 1 is a system for live streaming content including an image obtained through capturing by the streamer terminal 200A. The viewer terminal 200B is an example of a “display apparatus.” The streamer terminal 200A is an example of a “capturing apparatus.”

Live streaming refers to an activity in which a streamer and an unspecified viewer or a registered viewer participate, and the image based on a capturing result from the streamer terminal 200A is streamed in real-time to the viewer terminal 200B. The image may be a still image or a moving image.

The in-vehicle apparatus 30 is installed in the vehicle 3 and is wirelessly connected via short-range wireless communication or the like to the streamer terminal 200A possessed by a streamer S being an occupant of the vehicle 3.

The in-vehicle apparatus 30 receives, from the streamer terminal 200A, content data including an image captured by a camera included in the streamer terminal 200A and speech input via a microphone included in the streamer terminal 200A. The in-vehicle apparatus 30 uploads the received content data to the streaming server 100.

The streamer terminal 200A may be a smartphone, a tablet personal computer (PC) or the like as an example of the capturing apparatus. As long as the streamer S is displayed in the image obtained through the capturing by the streamer terminal 200A, the streamer terminal 200A may be placed at any location inside the vehicle 3. For example, the streamer terminal 200A is supported by a predetermined support provided at a passenger seat of the vehicle 3.

Note that the capturing apparatus provided in the vehicle 3 may be a camera such as a digital camera or a 360-degree camera that can capture an entire surrounding area and that can communicate with the in-vehicle apparatus 30. In this case, the microphone and the camera may be implemented separately.

The streaming server 100 stores the content received from the in-vehicle apparatus 30 in a server storage unit. The streaming server 100 streams the uploaded content data to the viewer terminal 200B of a viewer U. Live streaming technology can be realized using known technology such as HTTP Live Streaming (HLS), Common Media Application Format (CMAF), Web Real-Time Communication (WebRTC), or Real-Time Messaging Protocol (RTMP).

The viewer terminal 200B is a terminal apparatus possessed by the viewer U that views the content data streamed from the streaming server 100. FIG. 1 shows U1, U2, . . . , UN viewers U as the viewer U. N is an arbitrary natural number.

For example, the viewer terminal 200B may be a portable or mobile terminal apparatus such as a smartphone, tablet PC, or notebook PC, or may be a stationary terminal apparatus such as a desktop PC. The viewer terminal 200B may be a television set, or a head-mounted display apparatus in which an image display part is mounted on the head of the viewer U and a display included in the image display part is arranged in front of the eyes of the viewer U. The head-mounted display apparatus may be transmissive or non-transmissive, as long as the content streamed from the streaming server 100 can be viewed.

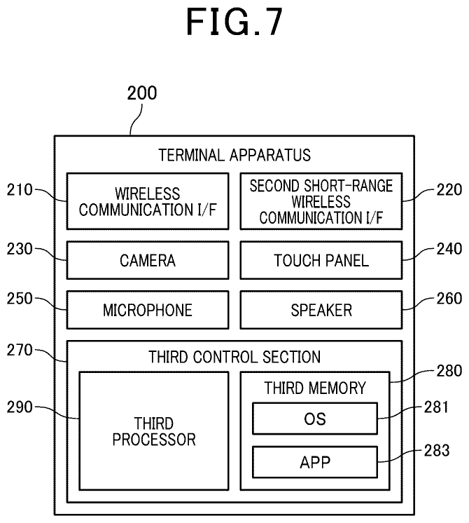

Hereinafter, the viewer terminal 200B includes a display 240 (see FIG. 7) and a speaker 260 (see FIG. 7), displays an image streamed from the in-vehicle apparatus 30 or the streaming server 100 on the display 240, and outputs speech streamed from the in-vehicle apparatus 30 or the streaming server 100 via the speaker 260.

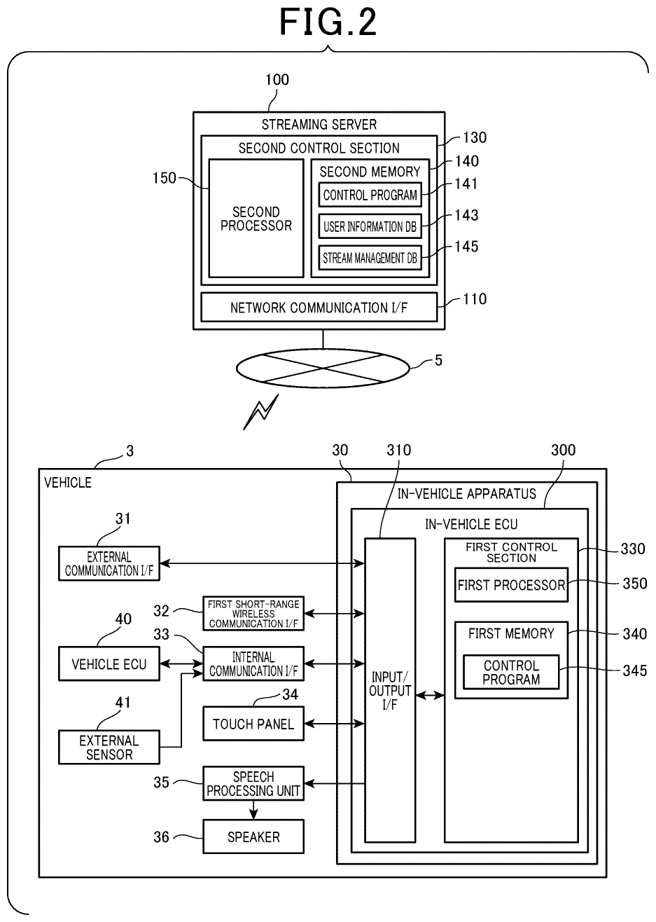

The viewer terminal 200B includes a microphone 250 (see FIG. 7) and uploads speech data of the viewer U collected by the microphone 250 to the streaming server 100. The streaming server 100 transmits the uploaded speech data of the viewer U to the in-vehicle apparatus 30. The in-vehicle apparatus 30 then outputs the speech indicated by the received speech data of the viewer U in the vehicle via a speaker 36 (see FIG. 2). With this, the viewer U and the streamer S can converse during the streaming of the content.

Hereinafter, the streamer terminal 200A and the viewer terminal 200B will be notated as a terminal apparatus 200 when collectively referring thereto.

A communication network 5 is a wired or wireless transmission path for information transmitted from an apparatus connected to the communication network 5. For example, the communication network 5 may include a public network such as the Internet, a mobile communication network, a satellite communication network, or various local area networks (LANs) including Ethernet (registered trademark) or a wide area network (WAN). The communication network 5 may include a dedicated network such as an Internet protocol-virtual private network (IP-VPN).

### 2. Configuration of In-Vehicle Apparatus

FIG. 2 is a diagram showing a configuration of the vehicle 3 and the streaming server 100.

First, the configuration of the vehicle 3 will be described with reference to FIG. 2.

The vehicle 3 includes the in-vehicle apparatus 30, an external communication interface 31, a first short-range wireless communication interface 32, an internal communication interface 33, a touch panel 34, a speech processing unit 35, the speaker 36, a vehicle electronic control unit (ECU) 40, an external sensor 41, and an in-vehicle ECU 300. Each communication interface includes a transmitter and a receiver. Hereinafter, interface will be abbreviated as I/F as appropriate.

The external communication I/F 31 is a communication module that performs wireless communication in accordance with a mobile communication standard such as long-term evolution (LTE), fourth-generation (4G), 5G, or Wi-Fi (registered trademark). The external communication I/F 31 is connected to the communication network 5 via an antenna (not shown) and performs mutual data transmission/reception with the streaming server 100.

For example, the first short-range wireless communication I/F 32 is a communication apparatus that performs wireless communication in accordance with a short-range wireless communication standard such as Bluetooth (registered trademark) or Wi-Fi. For example, the first short-range wireless communication I/F 32 is a communication module that performs communication in accordance with a near-field communication (NFC) standard such as Bluetooth or Wi-Fi. The first short-range wireless communication I/F 32 performs short-range wireless communication with a terminal apparatus possessed by an occupant and receives an image, speech, and the like captured by the terminal apparatus.

The internal communication I/F 33 is an input/output interface connected to an in-vehicle network (not shown). For example, a communication bus supporting a communication standard such as controller area network (CAN), CAN Flexible Data-Rate (CAN FD), or Ethernet is used for the in-vehicle network. The internal communication I/F 33 performs mutual data communication via the in-vehicle network with in-vehicle equipment such as the vehicle ECU 40 or another relay apparatus.

The touch panel 34 includes a display panel such as a liquid-crystal panel or an organic electroluminescent (EL) panel, and a touch sensor. The touch sensor detects a touch operation by the viewer U on the touch panel 34 and outputs position information indicating a position of the detected touch operation to a first control section 330.

For example, the speech processing unit 35 converts digital speech data output by the first control section 330 into an analog speech signal. The speech processing unit 35 includes an amplifier and amplifies the converted analog speech signal and outputs the amplified speech signal via the speaker 36.

The external sensor 41 detects a position of an object in a vicinity of the vehicle 3. The external sensor 41 includes, for example, a radar apparatus, a light detection and ranging (LIDAR) sensor, or various other proximity sensors. The radar apparatus emits radio waves such as millimeter waves in the vicinity of the vehicle 3, detects radio waves reflected by the object (reflected wave), and detects at least the position (distance and orientation) of the object. The radar apparatus may detect the position and a speed of the object using frequency-modulated continuous-wave (FM-CW) technology. The LIDAR sensor emits light (or electromagnetic waves with wavelengths close to that of light) in the vicinity of the vehicle 3, measures the scattered light, and detects a distance to a target based on the amount of time from light emission to light reception. The emitted light is, for example, pulsed laser light. The radar apparatus, the LIDAR sensor, or the like can be attached at a freely-selected location on or in the vehicle 3. The external sensor 41 includes, for example, an outdoor camera provided outside of the vehicle 3.

The in-vehicle ECU 300 includes an input/output I/F 310 and the first control section 330.

The input/output I/F 310 functions as a connection unit between the first control section 330 and the external communication I/F 31, the first short-range wireless communication I/F 32, the internal communication I/F 33, the touch panel 34, and the speech processing unit 35. The input/output I/F 310 includes a connector and an interface circuit. The input/output I/F 310 outputs data input from the external communication I/F 31, the first short-range wireless communication I/F 32, the internal communication I/F 33, the touch panel 34, the speech processing unit 35, and the external sensor 41 to the first control section 330. The input/output I/F 310 outputs data input from the first control section 330 to the external communication I/F 31, the first short-range wireless communication I/F 32, the internal communication I/F 33, the touch panel 34, or the speech processing unit 35.

The first control section 330 is a computer apparatus including a first memory 340 and a first processor 350.

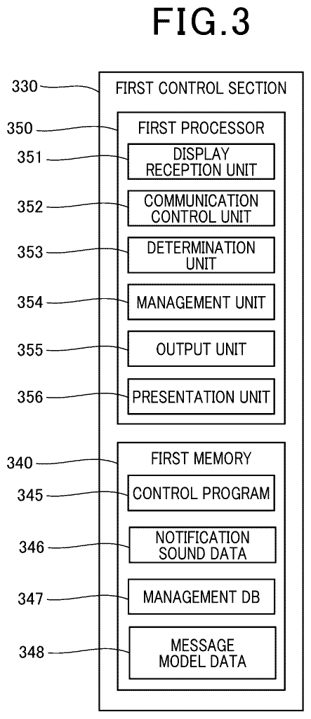

FIG. 3 is a diagram showing a detailed configuration of the first control section 330 of the in-vehicle apparatus 30.

The first memory 340 includes, for example, a volatile semiconductor memory and a non-volatile semiconductor memory. The first memory 340 may include only a non-volatile semiconductor memory. The first memory 340 may include an auxiliary storage apparatus such as a solid-state drive (SSD). The first memory 340 stores a control program 345 executed by the first processor 350, configuration data that defines an operation of the in-vehicle apparatus 30, and the like.

The first memory 340 stores notification sound data 346, a management database 347, and message model data 348.

The notification sound data 346 is data including sound data of each notification sound.

The notification sound is a notification sound indicating that the viewer terminal 200B has started viewing the streamed image. The notification sound data 346 includes sound data of a plurality of notification sounds that differ from each other.

One record R of the management database 347 includes terminal identification information of the viewer terminal 200B used by the viewer U, user information of the viewer U, and notification sound information. Hereinafter, database will be abbreviated as DB.

Among the viewer terminals 200B, a notification sound corresponding to a specific viewer terminal 200B differs from a notification sound corresponding to a viewer terminal 200B other than the specific viewer terminal 200B. Hereinafter, when distinguishing between the notification sound corresponding to the specific viewer terminal 200B and the notification sound corresponding to the viewer terminal 200B other than the specific viewer terminal 200B, the notification sound corresponding to the specific viewer terminal 200B is referred to as a first notification sound and the notification sound corresponding to the viewer terminal 200B other than the specific viewer terminal 200B is referred to as a second notification sound.

Here, the notification sound will be described in detail. The notification sound is a sound consisting of a predetermined scale pattern and a predetermined timbre.

The scale pattern is defined by an arrangement of a scale and intervals between notes. The scale is defined by frequency.

The predetermined timbre is defined by a waveform of the sound. For example, the timbre, that is, the waveform of the sounds differ from each other when instrument type is different, even if the scale pattern of two notification sounds is the same.

The first notification sound and the second notification sound differ from each other in at least any of the scale pattern and the timbre. With this, the streamer S can distinguish between the first notification sound and the second notification sound.

The notification sound may be speech that reads out specific text in accordance with the viewer terminal 200B having started viewing the image. For example, the notification sound may be speech that reads out the text “Mr. X has started watching,” where a name of the viewer U indicated in the user information is X.

Note that it is preferable for the notification sound to consist of a predetermined scale pattern and a predetermined timbre rather than being speech that reads out text, from the viewpoint of the degree of concentration of the streamer S on driving. Since the notification sound in the present embodiment consists of the predetermined scale pattern and the predetermined timbre, it is possible to notify the streamer S that viewing of the streamed image has started and to reduce a cognitive load of the streamer S.

The terminal identification information is identification information for uniquely identifying the terminal apparatus 200. The identification information is, for example, information indicating a serial code of the viewer terminal 200B.

The user information is personal information of the viewer U being a user. The user information includes, for example, information such as name, address, sex, and age. Furthermore, the user information includes information about a relation to the viewer U as seen from the streamer S. The relation is, for example, a kinship as seen from the streamer S (for example, grandmother, mother, or grandchild). The relation refers to, for example, the relation to the streamer S (for example, friend or workplace colleague).

The notification sound information is information for uniquely identifying the type of the notification sound included in the notification sound data 346.

The viewer U whose user information is stored in the management DB 347, corresponds to a registered viewer U.

The message model data 348 is data indicating a message model.

The message model is a model that outputs, using input information based on the user information as input, message information indicating a candidate message to be transmitted to a viewer of the viewer terminal 200B having started viewing the streamed image. The message model may be, for example, so-called generative artificial intelligence (AI). The message may be text.

The first processor 350 is, for example, an arithmetic processing apparatus such as a central processing unit (CPU) or a micro processing unit (MPU). The first processor 350 may be implemented as a single processor or as a plurality of processors. The first processor 350 may be implemented as a system on a chip (SoC) integrated with part or all of the first memory 340, or with another circuit.

The first processor 350 includes, as functional units, a display reception unit 351, a communication control unit 352, a determination unit 353, a management unit 354, an output unit 355, and a presentation unit 356. These functional units are realized through cooperation between hardware and software, by the first processor 350 loading and executing the control program 345 stored in the first memory 340. The communication control unit 352 is an example of a “streaming unit.”

The display reception unit 351 displays a screen, accepts an input operation, and the like via the touch panel 34.

The display reception unit 351 accepts a change in settings of the relationship in the user information of the viewer U corresponding to each piece of terminal identification information. The display reception unit 351 accepts a change in settings of the notification sound information corresponding to each piece of terminal identification information.

The communication control unit 352 communicates with the streaming server 100 and the viewer terminal 200B in accordance with a predetermined communication standard.

The communication control unit 352 uploads the content data to the streaming server 100 via the external communication I/F 31. The content data includes the image obtained through capturing by the streamer terminal 200A, speech obtained through sound collection by the streamer terminal 200A, a stream identification (ID), and the like.

The communication control unit 352 receives, from the viewer terminal 200B, a viewing start signal indicating that the viewer terminal 200B has started viewing the streamed image. The viewer terminal 200B having started viewing the streamed image indicates specifically that the viewer terminal 200B has started displaying the streamed image.

The determination unit 353 determines whether to output the notification sound via the output unit 355, based on traveling conditions of the vehicle 3.

The traveling conditions of the vehicle 3 include a travel speed of the vehicle 3, the types and the positions of the objects in the vicinity of the vehicle 3, and a road width of a road on which the vehicle 3 is traveling.

The determination unit 353 acquires the travel speed of the vehicle 3 via the vehicle ECU 40. The vehicle ECU 40 functions as an acquisition unit that acquires information relating to various operation of the vehicle 3. The vehicle ECU 40 acquires information related to behavior of vehicle 3 (for example, speed, acceleration, and steering angle) acquired by sensors installed in the vehicle 3, such as a speed sensor, a G sensor, a yaw-rate sensor, an orientation sensor, and a sensor that detects steering angle.

The determination unit 353 acquires the type and the position of the object in the vicinity of the vehicle 3 and the road width of the road on which the vehicle 3 is traveling, by estimating based on a detection result from the external sensor 41.

The determination unit 353 determines not to output the notification sound when the traveling conditions of the vehicle 3 are predetermined conditions. Specifically, the determination unit 353 sets an output prohibition flag when the traveling conditions of the vehicle 3 are the predetermined conditions, and clears the output prohibition flag when the traveling conditions of the vehicle 3 are not the predetermined conditions.

The predetermined conditions are conditions in which output of the notification sound is not appropriate from the viewpoint of the degree of concentration of the streamer S when driving the vehicle 3. In the predetermined conditions, there is a risk that the streamer S may have difficulty recognizing that the notification sound has been output due to the high cognitive load related to driving the vehicle, or that the streamer S is distracted from concentrating on driving the vehicle.

The predetermined conditions include a case in which the travel speed of the vehicle 3 is greater than or equal to a predetermined speed threshold value.

The predetermined conditions include a case in which an object is present in the vicinity that may collide with the vehicle 3 (for example, pedestrian or road accessory). Examples of the predetermined conditions in this case include conditions in which the vehicle 3 is traveling on a road in a downtown area or on a road with many pedestrians.

Furthermore, the predetermined conditions include a case in which the road width of the road on which the vehicle 3 is traveling is smaller than or equal to a predetermined width threshold value.

The determination unit 353 determines whether to present the message via the presentation unit 356, based on the traveling conditions of the vehicle 3.

The determination unit 353 determines not to present the message via the presentation unit 356 when the travel speed of the vehicle 3 is greater than or equal to the predetermined speed threshold value. Specifically, the determination unit 353 sets a presentation prohibition flag when the travel speed of the vehicle 3 is greater than or equal to the predetermined speed threshold value, and clears the presentation prohibition flag when the travel speed of the vehicle 3 is not greater than or equal to the predetermined speed threshold value.

The management unit 354 manages the management DB 347.

The management unit 354 sets the type of the notification sound corresponding to the viewer terminal 200B via a predetermined operation. The predetermined operation is performed, for example, via the touch panel 34. The predetermined operation may be performed via the streamer terminal 200A.

The management unit 354 sets the notification sound corresponding to the specific viewer terminal 200B to the first notification sound via the predetermined operation. The management unit 354 sets the notification sound corresponding to the viewer terminal 200B other than the specific viewer terminal 200B to the second notification sound via the predetermined operation.

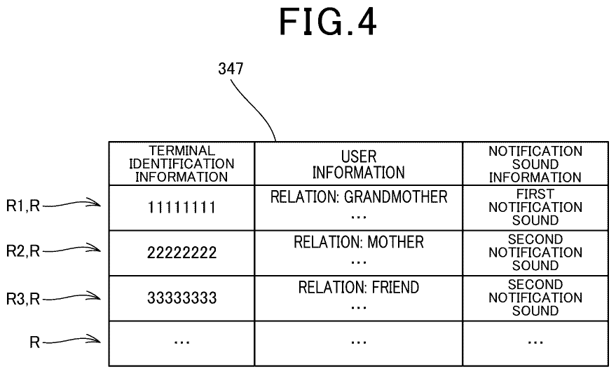

FIG. 4 is a diagram showing a configuration of a management DB 347.

FIG. 4 exemplifies a case in which the relation of the viewer U corresponding to the viewer terminal 200B is grandmother in a record R1, the relation of the viewer U corresponding to the viewer terminal 200B is mother in a record R2, and the relation of the viewer U corresponding to the viewer terminal 200B is friend in a record R3.

In the example of FIG. 4, the viewer terminal 200B used by the grandmother of the streamer S corresponds to the specific viewer terminal 200B, and the notification sound is the first notification sound. The viewer terminal 200B used by the mother or the friend of the streamer S corresponds to the viewer terminal 200B other than the specific viewer terminal 200B, and the notification sound is the second notification sound. A viewer terminal 200B not stored in the management DB 347 is also included in the viewer terminal 200B other than the specific viewer terminal 200B. That is, the notification sound corresponding to the unregistered viewer terminal 200B is the second notification sound.

In the example of FIG. 4, the notification sound corresponding to when the grandmother of the streamer S has started viewing differs from the notification sound corresponding to when the mother or the friend of the streamer S has started viewing. In this way, it is possible to cause the notification sound corresponding to the specific viewer terminal 200B to differ even among the viewer terminals 200B used by the registered viewers U.

The output unit 355 outputs, via the speaker 36, the notification sound indicating that the viewer terminal 200B has started viewing the streamed image. That is, when the communication control unit 352 receives the viewing start signal, the output unit 355 outputs the notification sound via the speaker 36.

The output unit 355 outputs the notification sound based on the management DB 347. That is, when the specific viewer terminal 200B for which the first notification sound is to be output has started viewing the streamed image, the output unit 355 outputs the first notification sound. When the viewer terminal 200B for which the second notification sound is to be output and a viewer terminal 200B not stored in the management DB 347 have started viewing the streamed image, the output unit 355 outputs the second notification sound.

The output unit 355 does not output the notification sound when the above-described output prohibition flag is set, but outputs the notification sound when the output prohibition flag has been cleared.

When the specific viewer terminal 200B starts viewing the streamed image, the presentation unit 356 presents the candidate message to be transmitted to the viewer terminal 200B having started viewing. In the present embodiment, the specific viewer terminal 200B is the viewer terminal 200B for which the notification sound is the first notification sound.

When the communication control unit 352 receives the viewing start signal, the presentation unit 356 presents the candidate message based on the user information indicated in the viewing start signal.

The presentation unit 356 uses the above-described message model and presents the candidate message based on the user information of the viewer U corresponding to the viewer terminal 200B having started viewing.

More specifically, the presentation unit 356 inputs, to the message model, a prompt including an instruction to generate a plurality of candidate message examples (for example, three) in accordance with attributes indicated in the user information, as the input information based on the user information. The presentation unit 356 presents the candidate messages indicated in the message information output from the message model in accordance with the prompt.

The presentation unit 356 presents the candidate messages by displaying text indicating the candidate messages on the display reception unit 351.

### 3. Configuration of Streaming Server

Next, a configuration of the streaming server 100 will be described.

The streaming server 100 includes a network communication I/F 110 and a second control section 130.

For example, the network communication I/F 110 includes a communication card such as a network interface card (NIC), and performs mutual data communication via the communication network 5 with the in-vehicle apparatus 30, the terminal apparatus 200, and the like.

The second control section 130 is a computer apparatus including a second memory 140 and a second processor 150.

The second memory 140 includes, for example, a volatile semiconductor memory and a non-volatile semiconductor memory. The second memory 140 may include only a non-volatile semiconductor memory. The second memory 140 may include an auxiliary storage apparatus such as a hard disk drive (HDD) or an SSD.

The second memory 140 stores a control program 141 executed by the second processor 150, a user information database 143, a stream management database 145, and a content database 147. Hereinafter, database will be abbreviated as DB.

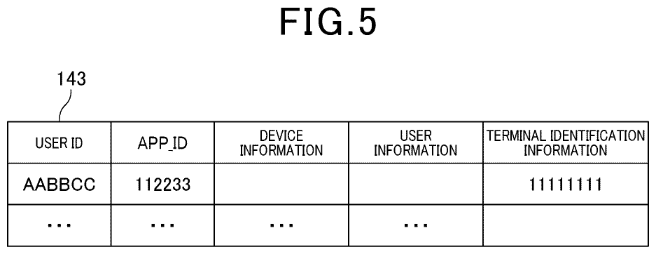

FIG. 5 is a diagram showing a configuration of the user information DB 143.

One record in the user information DB 143 includes a user ID, APP_ID, device information, the user information, and the terminal identification information. APP is an abbreviation of application program.

The user ID is identification information for identifying a user utilizing a streaming service provided by the streaming server 100. The user includes the streamer S and the viewer U.

APP_ID is identification information for identifying an application program downloaded on the streamer terminal 200A or the viewer terminal 200B.

The streamer S and the viewer U download the APP from a predetermined website and respectively install the APP on the streamer terminal 200A and the viewer terminal 200B.

The device information is identification information for identifying the terminal apparatus 200. The device information is, for example, information indicating whether the terminal apparatus 200 is a smartphone, a PC, a head-mounted display apparatus, or a camera. For example, a model number is used for the device information.

The user information is personal information of the streamer S and the viewer U being the user. The user information includes, for example, information such as name, address, sex, and age.

As described above, the terminal identification information is identification information for uniquely identifying the terminal apparatus 200. The viewer terminal 200B associated with information of the viewer U is uniquely identified, by associating the user information and the terminal identification information in the user information DB 143.

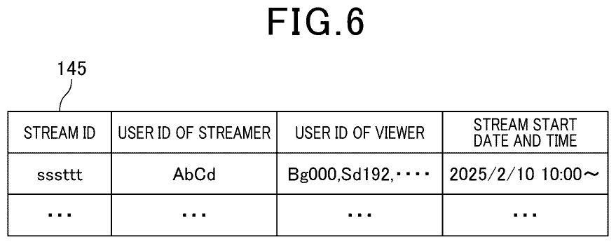

FIG. 6 is a diagram showing a configuration of the stream management DB 145.

One record in the stream management DB 145 includes a stream ID for identifying a stream, the user ID of the streamer S, the user ID of the viewer U, and a stream start date and time.

Returning to FIG. 2, the configuration of the streaming server 100 will be described further.

The second processor 150 is, for example, an arithmetic processing apparatus such as a CPU or an MPU. The second processor 150 may be implemented as a single processor or as a plurality of processors. The second processor 150 may be implemented as an SoC integrated with part or all of the second memory 140, or with another circuit.

### 4. Configuration of Terminal Apparatus

FIG. 7 is a block diagram showing a configuration of the terminal apparatus 200.

Since the configuration of the streamer terminal 200A and the viewer terminal 200B are substantially the same, description thereof will be based on the configuration of the terminal apparatus 200. In the following description, components of the streamer terminal 200A are denoted with reference sign “A” and components of the viewer terminal 200B are denoted with reference sign “B” for distinction. For example, a third control section 270 included in the streamer terminal 200A is notated as a “third control section 270A” and a third control section 270 provided in the viewer terminal 200B is notated as a “third control section 270B.”

The terminal apparatus 200 includes a wireless communication I/F 210, a second short-range wireless communication I/F 220, a camera 230, the display 240, the microphone 250, the speaker 260, and the third control section 270.

The wireless communication I/F 210 is a communication module that performs wireless communication in accordance with a mobile communication standard such as LTE, 4G, 5G, or Wi-Fi. The wireless communication I/F 210 is connected to the communication network 5 via an antenna (not shown) and performs mutual data transmission/reception with the streaming server 100.

For example, the second short-range wireless communication I/F 220 is a communication module that performs communication in accordance with an NFC standard such as Bluetooth or Wi-Fi. The second short-range wireless communication I/F 220 transmits a captured image captured by the camera 230, speech input via the microphone 250, and the like to the in-vehicle apparatus 30 through short-range wireless communication with the in-vehicle apparatus 30.

The camera 230 is a capturing apparatus including an image sensor and a data processing circuit. The image sensor is implemented as, for example, a charge-coupled device (CCD) or a complementary metal-oxide-semiconductor (CMOS). The data processing circuit generates a captured image from an output of the image sensor. The captured image generated by the camera 230 is transmitted to the in-vehicle apparatus 30 under the control of the third control section 270.

The microphone 250 is a speech input apparatus for inputting speech of the streamer S, the viewer U, and the like. The speaker 260 is a speech output apparatus for outputting speech of the streamer S, the viewer U, and the like.

The display 240 includes a display panel such as a liquid-crystal panel or an organic EL panel. When the terminal apparatus 200 is a smartphone, a tablet PC, or the like, the display 240 is a touch panel including a touch sensor.

In this case, the display 240 functions as a display part for displaying an image and as a reception part for accepting an operation by the streamer S, the viewer U, and the like.

Note that when the viewer terminal 200B is a head-mounted display apparatus, detection means for detecting a direction in which the eyes, the face, and the like of the viewer U are oriented or a gesture of the viewer U functions as a reception unit.

The third control section 270 is a computer apparatus including a third memory 280 and a third processor 290.

The third memory 280 includes a non-volatile semiconductor memory. The third memory 280 may include an auxiliary storage apparatus such as an SD card. The third memory 280 stores control programs such as an operating system (OS) 281 and an APP 283. The APP 283 is an application program that performs mutual data communication with the streaming server 100, displays a moving image included in content streamed by the streaming server 100 on a display 240B, and outputs speech included in the content to the speaker 260.

The third processor 290 is, for example, an arithmetic processing apparatus such as a CPU or an MPU. The third processor 290 may be implemented as a single processor or as a plurality of processors.

Upon starting viewing of the streamed image, a third processor 290B transmits the above-described viewing start signal to the in-vehicle apparatus 30.

### 5. Operation

Next, an operation of the streaming system 1 will be described.

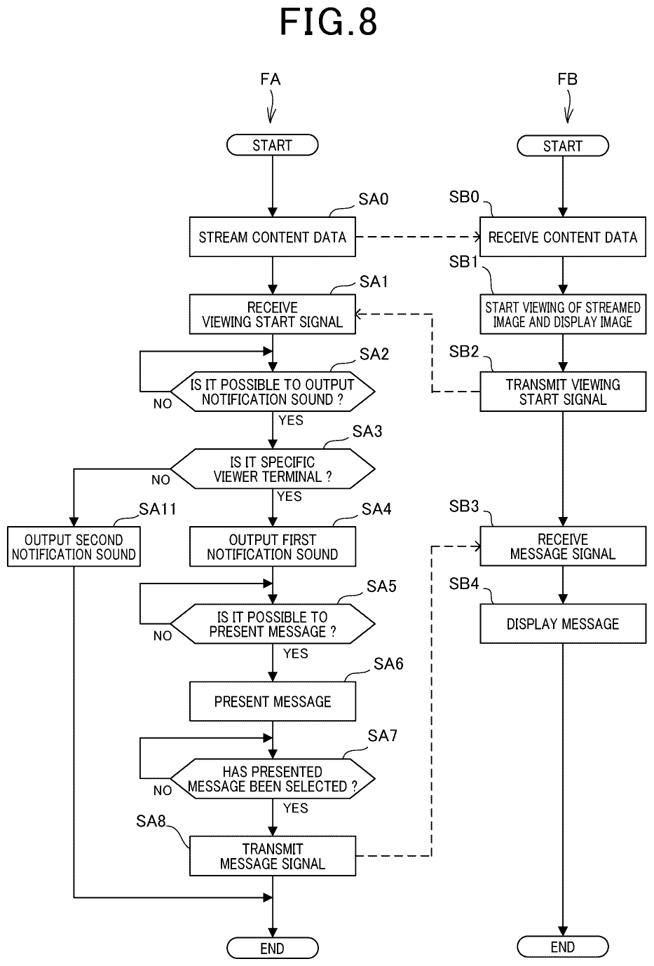

FIG. 8 shows flowcharts showing an operation of the in-vehicle apparatus 30 and the viewer terminal 200B.

In the operation of the in-vehicle apparatus 30 and the viewer terminal 200B described in FIG. 8, it is assumed that communication is established between the in-vehicle apparatus 30 and the streaming server 100 and between the streaming server 100 and the viewer terminal 200B, and that the viewer terminal 200B can start viewing the streamed image.

As shown in a flowchart FA, the communication control unit 352 streams the image obtained through capturing by the capturing apparatus. More specifically, the communication control unit 352 streams content data including video and speech (step SA0), and the third processor 290B receives the content data as shown in a flowchart FB (step SB0). Step SA0 is an example of a “streaming step.”

Note that the communication between the in-vehicle apparatus 30 and the viewer terminal 200B may or may not go through the streaming server 100.

Next, as shown in the flowchart FB, the third processor 290B of the viewer terminal 200B starts viewing the image streamed from the in-vehicle apparatus 30 and displays the image (step SB1). Step SB1 is an example of a “display step.”

Next, the third processor 290 transmits, to the in-vehicle apparatus 30, the viewing start signal indicating that viewing of the image has started (step SB2).

Next, as shown in the flowchart FA, the communication control unit 352 receives the viewing start signal from the viewer terminal 200B (step SA1), and the determination unit 353 determines whether to output the notification sound (step SA2).

When the determination unit 353 determines to output the notification sound (YES in step SA2), the output unit 355 determines whether the viewer terminal 200B is the specific viewer terminal 200B based on the terminal identification information included in the viewing start signal and the management DB 347 (step SA3). When the viewer terminal 200B is not the specific viewer terminal 200B, the output unit 355 outputs the second notification sound (step SA11) and ends the processing. When the viewer terminal 200B is the specific viewer terminal 200B, the output unit 355 outputs the first notification sound (step SA4). Step SA3 is an example of a “notification execution determination step.” Steps SA4 and SA11 are examples of an “output step.”

Next, the determination unit 353 determines whether to present the message (step SA5). Step SA5 is an example of a “presentation execution determination step.”

When the determination unit 353 determines to present the message (YES in step SA5), the presentation unit 356 presents the message based on the user information included in the viewing start signal (step SA6). Step SA6 is an example of a “presentation step.” In step SA6, the display reception unit 351 displays a presentation screen including the candidate messages as text.

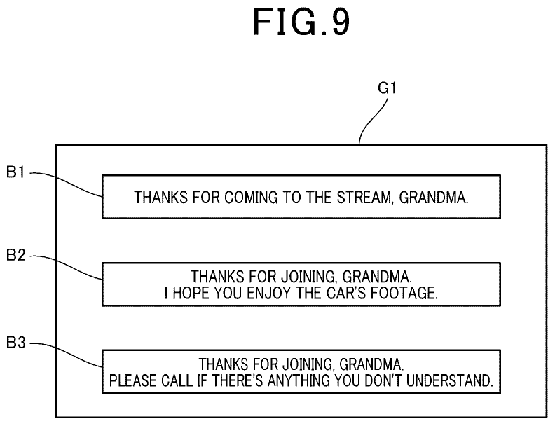

Here, an example of the presentation screen will be described. FIG. 9 is a diagram showing an example of a presentation screen G1.

The presentation screen G1 is a screen displayed on the touch panel 34. In the example of FIG. 9, this corresponds to a case in which the user information indicates that the relation to the streamer S is that of grandmother.

The presentation screen G1 includes a first button B1, a second button B2, and a third button B3, each including text of one of three candidate messages.

The first button B1 includes the text “Thanks for coming to the stream, Grandma.”

The second button B2 includes the text “Thanks for joining, Grandma. I hope you enjoy the car's footage.”

The third button B3 includes the text, “Thanks for joining, Grandma. Please call if there's anything you don't understand.”

The first button B1, the second button B2, and the third button B3 are software buttons.

Returning to the description of the operation of the in-vehicle apparatus 30 shown in the flowchart FA, the display reception unit 351 determines whether the presented message has been selected (step SA7), and when the message is selected (YES in step SA7), the communication control unit 352 transmits a message signal including information of the selected message to the viewer terminal 200B (step SA8).

Note that after step SA6 ends, there may be a case in which the presentation prohibition flag is set after candidate messages are presented when the speed of vehicle 3 is high and is greater than or equal to the speed threshold value. In this case, a different screen may be displayed instead of the presentation screen G1 while the presentation prohibition flag has been set, and the presentation screen G1 is displayed only when the presentation prohibition flag is cleared.

Returning to the description of the operation of the viewer terminal 200B, the third processor 290 receives the message signal as shown in the flowchart FB (step SB3). Next, the third processor 290 displays the message indicated in the message signal (step SB4). In step SB4, an already-streamed image is displayed on the viewer terminal 200B. The message is, for example, displayed superimposed on the streamed image.

### Other Embodiments

The above-described embodiment indicates merely one aspect and can be freely modified and applied.

In the above-described embodiment, a configuration has been exemplified in which the notification sound corresponding to the specific viewer terminal 200B among the registered viewer terminals 200B is set as the first notification sound, as a configuration in which it is possible to cause the notification sound corresponding to the specific viewer terminal 200B to differ even among the viewer terminals 200B used by the registered viewers U, but the present invention is not limited thereto. For example, the notification sound corresponding to a registered viewer terminal 200B may be the first notification sound and the notification sound corresponding to an unregistered viewer terminal 200B may be the second notification sound.

The notification sound may include a third notification sound different from the first notification sound and the second notification sound. In this case, for example, the notification sound corresponding to the specific viewer terminal 200B among the registered viewer terminals 200B may be the first notification sound, the notification sound corresponding to a viewer terminal 200B other than the specific viewer terminal 200B may be the second notification sound, and the notification sound corresponding to an unregistered viewer terminal 200B may be the third notification sound.

The determination unit 353, the management unit 354, the output unit 355, and the presentation unit 356 included in the in-vehicle apparatus 30 may be included in the streaming server 100. The notification sound data 346, the management database 347, and the message model data 348 stored in the first memory 340 of the in-vehicle apparatus 30 may be stored in the streaming server 100. In this case, the management database 347 and the user information DB 143 may be configured so that one includes the other.

A case has been exemplified in which the message model is a generative AI, but the present invention is not limited thereto. The message model may be a rule-based model.

The traveling conditions of the vehicle 3 may include conditions of the occupant of the vehicle 3. In addition to the above-described embodiment, the determination unit 353 may estimate the conditions of the occupant based on the image captured by the capturing apparatus. The condition of the occupant refers to the degree of concentration of the occupant on driving. In this case, the determination unit 353 uses a model to estimate the degree of concentration on driving from the occupant captured in the image. When the degree of concentration of the driver on driving is high, the determination unit 353 may determine to output the notification sound even when the traveling conditions of the vehicle 3 are the predetermined conditions.

In the above-described embodiment, the communication control unit 352 of the in-vehicle apparatus 30 uploads the content data to the streaming server 100 via the external communication I/F 31. In another embodiment, the streamer terminal 200A may upload the content data to the streaming server 100. More specifically, in this case, the streamer terminal 200A uploads, to the streaming server 100, the content data including the image captured by the camera included in the streamer terminal 200A and the speech input via the microphone included in the streamer terminal 200A.

The first processor 350 and the second processor 150 may be implemented as a single processor or as a plurality of processors. The first processor 350 and the second processor 150 may be hardware programmed to realize the above-described functional units. In this case, these processors are, for example, implemented as an application-specific integrated circuit (ASIC) or a field-programmable gate array (FPGA).

The configuration of each unit of the streaming server 100, the vehicle 3, and the terminal apparatus 200 shown in FIGS. 2, 3, and 7 are merely examples, and specific implementation forms thereof are not particularly limited. In other words, it is not necessarily required that separate pieces of hardware be provided for the respective components, and the functions of the respective components may, of course, be realized by a single processor executing a program. Some functions realized by software in the above-described embodiment may be realized by hardware, or alternatively, some functions realized by hardware may be realized by software.

The step units of the operation shown in FIG. 8 are divided in accordance with their main processing content, and the present invention is not limited by the manner in which the processing units are divided or by the names assigned to those processing units. One step unit may be divided into a greater number of step units in accordance with the processing content. One step unit may be divided so as to include a greater amount of processing. The order of these steps may be rearranged as appropriate so as not to impede on the gist of the present invention.

### 6. Configurations Supported by the Above Embodiment

The above embodiment supports the following configurations.

### Configuration 1

A streaming system including: a streaming unit configured to stream an image obtained through capturing by a capturing apparatus provided in a vehicle; a display apparatus configured to display the image streamed by the streaming unit and provided outside of the vehicle; and an output unit configured to output, from a speaker provided in the vehicle, a notification sound indicating that the display apparatus has started viewing the image, wherein the notification sound corresponding to a specific display apparatus differs from the notification sound corresponding to a display apparatus other than the specific display apparatus.

According to the streaming system of configuration 1, the notification sound different from the notification sound of the display apparatus other than the specific display apparatus is output when the specific display apparatus starts viewing the streamed image. Thus, it is possible for an occupant to know when viewing of the streamed image on the specific display apparatus has started and to reduce a load related to the occupant recognizing a notification indicating that viewing of the streamed image on the specific display apparatus has started.

### Configuration 2

The streaming system according to configuration 1, including a determination unit configured to determine whether to output the notification sound via the output unit, based on traveling conditions of the vehicle.

According to the streaming system of configuration 2, it is possible not to output the notification sound when the traveling conditions of the vehicle are predetermined conditions. Thus, it is possible to suppress the notification interfering with the traveling of the vehicle in accordance with the traveling conditions of the vehicle.

### Configuration 3

The streaming system according to configuration 2, including a presentation unit configured to present, to an occupant of the vehicle, a candidate message to be transmitted to the specific display apparatus, when the specific display apparatus has started viewing the image and the determination unit determines that a speed of the vehicle is less than or equal to a predetermined value.

According to the streaming system of configuration 3, the candidate message is presented to a specific viewer having started viewing the streamed image. Thus, the occupant can easily transmit a message to the specific viewer. The candidate message is presented when the speed of the vehicle is less than or equal to the predetermined value. Thus, it is possible to suppress the presenting of the candidate message interfering with the traveling of the vehicle.

### Configuration 4

A streaming method including: a streaming step of streaming an image obtained through capturing by a capturing apparatus provided in a vehicle; a display step of displaying, by a display apparatus provided outside of the vehicle, the image streamed in the streaming step; and an output step of outputting, from a speaker provided in the vehicle, a notification sound indicating that the display apparatus has started viewing the image, wherein the notification sound corresponding to a specific display apparatus differs from the notification sound corresponding to a display apparatus other than the specific display apparatus.

According to the streaming method of configuration 4, it is possible to achieve the same effects as in configuration 1.

### Configuration 5

A non-transitory computer-readable storage medium storing a program for causing a processor of an in-vehicle apparatus to function as: a streaming unit configured to stream to a display apparatus provided outside of a vehicle and configured to display an image obtained through capturing by a capturing apparatus provided in the vehicle; and an output unit configured to output, from a speaker provided in the vehicle, a notification sound indicating that the display apparatus has started viewing the image, wherein the notification sound corresponding to a specific display apparatus differs from the notification sound corresponding to a display apparatus other than the specific display apparatus.

According to the non-transitory computer-readable storage medium of configuration 5, it is possible to achieve the same effects as in configuration 1.

### Configuration 6

An in-vehicle apparatus including: a streaming unit configured to stream to a display apparatus provided outside of a vehicle and configured to display an image obtained through capturing by a capturing apparatus provided in the vehicle; and an output unit configured to output, from a speaker provided in the vehicle, a notification sound indicating that the display apparatus has started viewing the image, wherein the notification sound corresponding to a specific display apparatus differs from the notification sound corresponding to a display apparatus other than the specific display apparatus.

According to the in-vehicle apparatus of configuration 6, it is possible to achieve the same effects as in configuration 1.

### REFERENCE SIGNS LIST

1 streaming system
3 vehicle
5 communication network
30 in-vehicle apparatus
31 external communication I/F
32 first short-range wireless communication I/F
33 internal communication I/F
34 touch panel
35 speech processing unit
36 speaker
40 vehicle ECU
41 external sensor
100 streaming server
110 network communication I/F
130 second control section
140 second memory
141 control program
143 user information database
145 stream management database
147 content database
150 second processor
200 terminal apparatus
200A streamer terminal (capturing apparatus)
200B viewer terminal (display apparatus)
210 wireless communication I/F
220 second short-range wireless communication I/F
230 camera
240 display
250 microphone
260 speaker
270 third control section
280 third memory
281 OS
283 APP
290 third processor
290B third processor
300 in-vehicle ECU
310 input/output I/F
330 first control section
340 first memory
345 control program
346 notification sound data
347 management database
348 message model data
350 first processor
352 communication control unit (streaming unit)
353 determination unit
354 management unit
355 output unit
356 presentation unit
B1 first button
B2 second button
B3 third button
G1 presentation screen
S streamer (occupant)
U viewer

1. A streaming system comprising:
a streaming unit configured to stream an image obtained through capturing by a capturing apparatus provided in a vehicle;
a display apparatus configured to display the image streamed by the streaming unit and provided outside of the vehicle; and
an output unit configured to output, from a speaker provided in the vehicle, a notification sound indicating that the display apparatus has started viewing the image, wherein
the notification sound corresponding to a specific display apparatus differs from the notification sound corresponding to a display apparatus other than the specific display apparatus.

2. The streaming system according to claim 1, comprising a determination unit configured to determine whether to output the notification sound via the output unit, based on traveling conditions of the vehicle.

3. The streaming system according to claim 2, comprising a presentation unit configured to present, to an occupant of the vehicle, a candidate message to be transmitted to the specific display apparatus, when the specific display apparatus has started viewing the image and the determination unit determines that a speed of the vehicle is less than or equal to a predetermined value.

4. A streaming method comprising:
a streaming step of streaming an image obtained through capturing by a capturing apparatus provided in a vehicle;
a display step of displaying, by a display apparatus provided outside of the vehicle, the image streamed in the streaming step; and
an output step of outputting, from a speaker provided in the vehicle, a notification sound indicating that the display apparatus has started viewing the image, wherein
the notification sound corresponding to a specific display apparatus differs from the notification sound corresponding to a display apparatus other than the specific display apparatus.

5. A non-transitory computer-readable storage medium storing a program for causing a processor of an in-vehicle apparatus to function as:
a streaming unit configured to stream to a display apparatus provided outside of a vehicle and configured to display an image obtained through capturing by a capturing apparatus provided in the vehicle; and
an output unit configured to output, from a speaker provided in the vehicle, a notification sound indicating that the display apparatus has started viewing the image, wherein
the notification sound corresponding to a specific display apparatus differs from the notification sound corresponding to a display apparatus other than the specific display apparatus.

6. An in-vehicle apparatus comprising:
a streaming unit configured to stream to a display apparatus provided outside of a vehicle and configured to display an image obtained through capturing by a capturing apparatus provided in the vehicle; and
an output unit configured to output, from a speaker provided in the vehicle, a notification sound indicating that the display apparatus has started viewing the image, wherein
the notification sound corresponding to a specific display apparatus differs from the notification sound corresponding to a display apparatus other than the specific display apparatus.
